(19) United States
(12) Patent Application Publication
(10) Pub. No.: US 2012/0099496 A1
(43) Pub. Date: Apr. 26, 2012

(54) Methods circuits devices and systems for collocating a digital video receiver with a digital data transceiver

(76) Inventor: Itzik Klein, Kfar-Monash (IL)

(21) Appl. No.: 12/926,074

(22) Filed: Oct. 25, 2010

(51) Int. Cl. H04W 52/02

(52) U.S. Cl. 370/311

(57) ABSTRACT

Disclosed are methods, circuits, devices and systems for collocating a digital video receiver and a digital data transceiver. According to embodiments, a mobile digital video receiver may include a wireless receiver controller adapted to generate and transmit to a functionally associated wireless data transceiver an indication of an expected arrival of a digital video frame. The indication may be adapted to cause the functionally associated wireless data transceiver to generate and transmit to one or more wireless data transmitters an indicator signal or packet indicating that the wireless data transceiver is entering a low-power or standby mode/state for some predefined period of time.

### FIELD OF THE INVENTION

The present invention relates generally to the field of communication. More specifically, the present invention relates to methods, circuits, devices and systems for collocating a digital video receiver and a digital data transceiver-optionally mitigating interference between the two.

### BACKGROUND

Since the development of crude communication systems based on electrical signals, the world's appetite for more and more advanced forms of communication has continually increased. From wired cable networks over which operators would exchange messages using Morse-Code, to the broadband wireless networks of today, whenever technology has provided a means by which to communicate more information, people have found a use for that means, and have demanded more.

Modern communication networks are best characterized by features such as high bandwidth/data-rate, complex communication protocols, various transmissions medium, and various access means. Fiber optic networks span much of the world's surface, acting as long-haul networks for carrying tremendous amounts of data between distant points on the globe. Cable and other wire-based networks supplement coverage provided by fiber optic networks, where fiber networks have not yet been installed, and are still used as part of local area networks (“LAN”), for carrying data between points relatively close to one another. In addition to wire-based networks, wireless networks such as cellular networks (e.g. 2G, 3G, CDMA, WCDMA, WiMAX, etc.) are used to supplement coverage for various devices (e.g. cell phone, wireless IP phone, wireless Internet appliance, etc.) not connected to a fixed network connection. Wireless networks may act as complete local loop networks and may provide a complete wireless solution, where a communication device in an area may transmit and receive data from another device entirely across the wireless network.

With the proliferation of communication networks and the world's growing reliance upon them, proper performance is crucial. High data rates and stable communication parameters at low power consumption levels are highly desirable for communication devices.

In addition to the advancements in wireless communications and the growing use of wireless networks, wireless devices that traditionally used to be separate are now being integrated into a single device. This integration puts the wireless devices in great proximity, causing interference between the devices. An example of an integrated wireless device is a smart phone having a primary cellular wide area network (WAN) and perhaps WiFi local area network (LAN), and a Bluetooth wireless connection. Having these three wireless communicating devices built into a small device such as a cellular phone, and having them in close proximity to one another, imposes great challenge of eliminating interference among them.

Another field in which integration of several wireless communication technologies is becoming more and more popular is integration of mobile digital TV and data communication. Examples may include a PC with a mobile digital TV card and WiFi card, or a Laptop computer with a mobile digital TV card and WiFi connectivity, or a mobile digital television set with a WiFi connection, or even a cell-phone or a smart-phone with an integrated mobile digital TV receiver. These cases are characterized by a connectionless channel (digital TV signal) which may be interfered by another signal (WiFi) without an ability to recover lost data. In all these cases it is crucial to eliminate the TV signal from being interfered by other wireless signals in the TV receiver proximity while still enabling simultaneous TV reception and wireless data (e.g. WiFi) communication.

Therefore, there exists a need in the field of wireless communications for a method, circuit/device and system for eliminating interference of a TV signal.

### SUMMARY OF THE INVENTION

The present invention includes methods, circuits, devices and systems for facilitating mobile digital video (MDTV) reception in along with wireless data communication. According to some embodiments of the present invention, a mobile digital television receiver (“MDTVR”) may be collocated in proximity with a data transceiver (e.g. WiFi). The MDTVR may generate a signal to the data transceiver indicating an expected MDTV transmission frame which the MDTVR is expecting to receive. The data transceiver may respond to the signal from the MDTVR by generating and wirelessly transmitting a signal to one or more other wireless data transmitters in proximity of itself, wherein the transmitted wireless signal may include an indicator signal or packet indicating to the one or more other wireless data transmitters that the data transceiver is entering a low-power or standby mode/state for some predefined period of time. The low-power or standby mode/state indicator may cause the one or more other wireless data transmitters in proximity to the transceiver to refrain from transmitting data to the data transceiver during the predefined period. According to further embodiments of the present invention, the predefined period of time may be associated with a duration of the expected MDTV transmission frame. According to further embodiments, the indicated predefined period of time may be longer than the expected frame duration, optionally taking into account overhead associated with expected time till the next frame starts and some period of time after the next frame is to end.

According to further embodiments of the present invention, the MDTVR may be adapted to detect, determine or estimate one or more parameters associatedwith a pattern (e.g. duration, duty cycle, frame start point, etc.) of recurring/periodic MDTV transmission frames being transmitted by an DTV/MDTV source. According to yet further embodiments of the present invention, the signal generated by the MDTVR may indicate to the functionally associated transceiver the one or more parameters associated with the recurring/periodic MDTV frame reception. Based on the signal indicating the one or more parameters associated with the recurring/periodic MDTV frame reception, the functionally associated transceiver may determine or estimate during which time periods a MDTV is to be received. Optionally, the functionally associated data transceiver may generate and transmit to the one or more other transmitters a low-power/standby indicator prior to the time periods during which a MDTV is determined or estimated to be received. The one or more other transmitters may refrain from transmitting to the transceiver during those time periods an MDTV frame was determined/estimated is to be received based on the signal indicating the one or more parameters. According to some embodiments, the MDTVR may be integral with and/or share resources (e.g. controller, control logic, decoders, processing, and radio frequency circuitry) with the data transceiver.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows an exemplary entertainment device according to some embodiments of the present invention, which includes a WiFi data link and a MDTVR dongle plugged into it;

FIG. 2 shows an exemplary timing diagram of a DTV signal;

FIG. 3 is an exemplary system including an entertainment device having a MDTV receiver receiving a DTV signal from a broadcasting station, and a WiFi transceiver communicating with a WiFi access point;

FIG. 4 is an exemplary timing diagram showing the correlation between the DTV signal, the quiet state, and the data signal, according to some embodiments of the present invention; and

FIG. 5 is an exemplary flowchart describing the steps taken by the first wireless data transceiver according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

It is understood that the term WiFi Standard may refer to such specific standards such as 802.11a, 802.11b, 802.11g, 802.11n, and/or any other certified or known standard.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

According to embodiments, a wireless data transceiver may include a transceiver controller adapted to receive from a functionally associated wireless digital video receiver an indication of expected arrival of a digital video frame and to respond to the indication by generating and transmitting to one or more wireless data transmitters a wireless indicator signal or packet indicating that said wireless data transceiver is entering a low-power or standby mode/state for some predefined period of time. The transceiver may comprise radio frequency transmission circuitry. The transceiver may comprise radio frequency reception circuitry. The transceiver may be adapted to operate substantially in accordance with the WiFi standard. The controller may be adapted to receive from the functionally associated wireless digital video receiver a signal indicating one or more parameters associated with a pattern of recurring/periodic MDTV frame reception. The one or more parameters may be selected from the group consisting of duration of frame, interval between consecutive frames, and temporal reference point/time. The controller may be further adapted to determine or estimate during which time periods a MDTV frame is to be received based on the signal indicating the one or more parameters. The controller may be further adapted to intermittently transmit a wireless indicator signal or packet indicating that said wireless data transceiver is entering a low-power or standby mode/state for some predefined period of time prior to the determined or estimated time period.

According to further embodiments, a mobile digital video receiver may include a wireless receiver controller adapted to generate and transmit to a functionally associated wireless data transceiver an indication of an expected arrival of a digital video frame. The indication may be adapted to cause the functionally associated wireless data transceiver to generate and transmit to one or more wireless data transmitters an indicator signal or packet indicating that the wireless data transceiver is entering a low-power or standby mode/state for some predefined period of time. The receiver may include radio frequency reception circuitry. The radio frequency reception circuitry may be adapted to operate substantially in accordance with an MDTV standard. The controller may be adapted to detect, determine or estimate one or more parameters associated with a pattern of recurring/periodic MDTV frame reception. The one or more parameters may be selected from the group consisting of duration of frame, interval between consecutive frames, and temporal reference point/time. The controller may further be adapted to convey the one or more parameters to the functionally associated wireless data transceiver.

In wireless applications there may be cases in which a wireless transmitter or transceiver may be collocated with, or located in proximity to, a wireless receiver. In such cases the receiver's reception may be interfered by the transmitter/transceiver when it is transmitting. One such case may be the case of having digital televisions (DTV) or mobile digital television receivers (MDTVR) combined with WiFi. Other cases may be desktop computers or laptop computers having a WiFi card or circuit, and a MDTVR card or dongle. Other examples may include handheld devices such as mobile phones, iPod, tablet computers and the like, with WiFi connectivity and MDTVR reception capabilities. All of these cases may include a WiFi transceiver in proximity to a DTV receiver. In these cases, when the WiFi transceiver transmits a data signal, it may interfere the video signal reception by the DTV receiver.

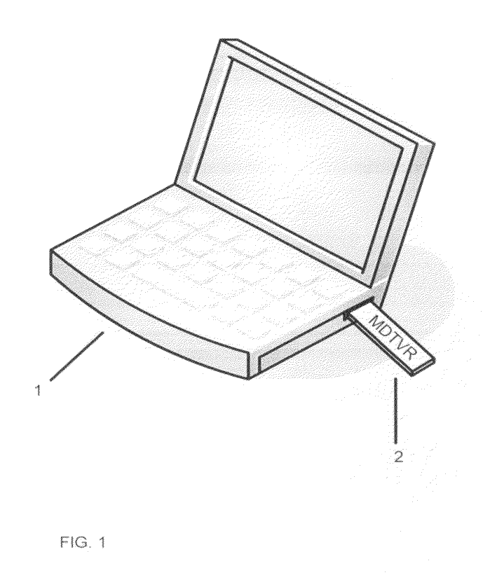

FIG. 1 shows an exemplary application according to some embodiments of the present invention. According to this example there may be an entertainment device (1) such as a laptop computer having an internal WiFi card and an external MDTVR dongle (2).

According to some embodiments of the present invention, a DTV signal of a DTV service may be constructed of frames of a certain duration which may be received at a certain rate. According to some embodiments of the present invention, the frame duration may vary. According to some embodiments of the present invention, the frame rate may vary.

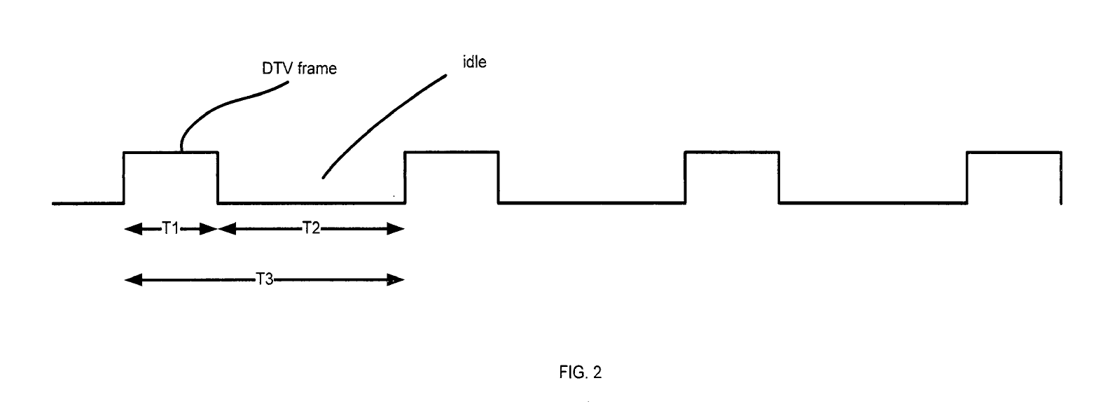

FIG. 2 shows an example of a DTV signal timing, T1 may be the duration of the frame, T2 may be the gap time in between two frames, T3 may be the time from the start of transmission of a frame to the start of transmission of the next frame. The DTV frame rate may be 1/T3.

According to some embodiments of the present invention, there may be an entertainment device which may be capable of DTV or MDTV reception, and performing data communication over a wireless data link (e.g. WiFi).

According to some embodiments of the present invention, there may be a DTV or MDTV receiver circuit adapted to receive a wireless digital video signal or frames transmitted by a digital video source (e.g. digital TV broadcasting station).

According to some embodiments of the present invention, there may be a first wireless data transceiver circuit adapted to transmit and/or receive a wireless data signal or packets.

According to some embodiments of the present invention, there may be a second wireless data transceiver circuit adapted to transmit and/or receive a wireless data signal or packets.

According to some embodiments of the present invention, the first wireless data transceiver circuit may enter a quiet state for a certain period of time. According to some embodiments of the present invention, during the quiet state the first wireless data transceiver may not transmit any wireless signal.

According to some embodiments of the present invention, the first and second data transceiver circuits may communicate wirelessly to perform a wireless data link. According to some embodiments of the present invention, the first and second data transceiver circuits may communicate wirelessly to exchange data and/or information between them.

According to some embodiments of the present invention, the entertainment device may include, or otherwise be attached to and communicate with, a DTV or MDTV receiver circuit. According to some embodiments of the present invention, the entertainment device may include, Or otherwise be attached to and communicate with, a first wireless data transceiver circuit (e.g. WiFi). According to some embodiments of the present invention, the entertainment device may be adapted to receive a DTV signal through the DTV or MDTV receiver circuit, while being capable of simultaneously performing wireless data communication through the wireless data link circuit. According to some embodiments of the present invention, the first wireless data transceiver circuit and the DTV/MDTV circuit may have a communication channel between them. According to some embodiments of the present invention, the communication channel may be a direct connection between the two circuits. According to some embodiments of the present invention, the first wireless data transceiver circuit and the DTV/MDTV circuit may communicate between them through the entertainment device's main processor or through shared memory, or through a bus, or in any other way.

According to some embodiments of the present invention, there may be a second wireless data transceiver (e.g WiFi access point) in proximity to the entertainment device. According to some embodiments of the present invention, the second wireless data transceiver may communicate with the first wireless data transceiver which is included in, or attached to the entertainment device. According to some embodiments of the present invention, the second wireless data transceiver may send a signal or a packet to the first wireless data transceiver. According to some embodiments of the present invention, upon sending a signal or a packet to the first wireless data transceiver, the second wireless data transceiver may wait and expect a reply message, or signal from the first wireless data transceiver. According to some embodiments of the present invention, if the second wireless data transceiver does not receive a reply, it may retransmit the message to the first wireless data transceiver.

In order to prevent the first wireless data transceiver from transmitting during the time that a DTV signal is being received by the DTV receiver, and interfering the DTV receiver's reception, the first wireless data transceiver may need to enter a quiet state in which it will not transmit while the DTV receiver is receiving a video data packet or signal. When the first wireless data transceiver enters the quiet state, it may need to inform the second wireless data transceiver that it has entered a quiet state so that the second wireless data transceiver will know not to transmit a signal or a packet to the first wireless data transceiver during the quiet period, or if it transmits a signal or packet to the first wireless data transceiver, it will know not to expect a timely or any reply. During the quiet state, the second wireless data transceiver may buffer any data it was supposed to send during that time and send it after the quiet state ends.

According to some embodiments of the present invention, the first wireless data transceiver may send a signal or a packet to the second wireless data transceiver informing it that it may be entering a quiet state for a certain period of time. According to some embodiments of the present invention, the first wireless data transceiver may send a signal or a packet to the second wireless data transceiver informing it that it is entering a quiet state, and send another signal or packet informing the second wireless data transceiver that it is exiting the quiet state. According to some embodiments of the present invention, the DTV/MDTV receiver may inform the first wireless data transceiver of an expected video signal or frame it is about to receive. According to some embodiments of the present invention, the quiet state time and duration may be associated with the estimated time and duration in which the DTV receiver is about to receive a DTV signal or frame. According to some embodiments of the present invention, the quiet state duration may be extended to include a time overhead before and/or after the estimated time in which the DTV signal or frame is about to be received.

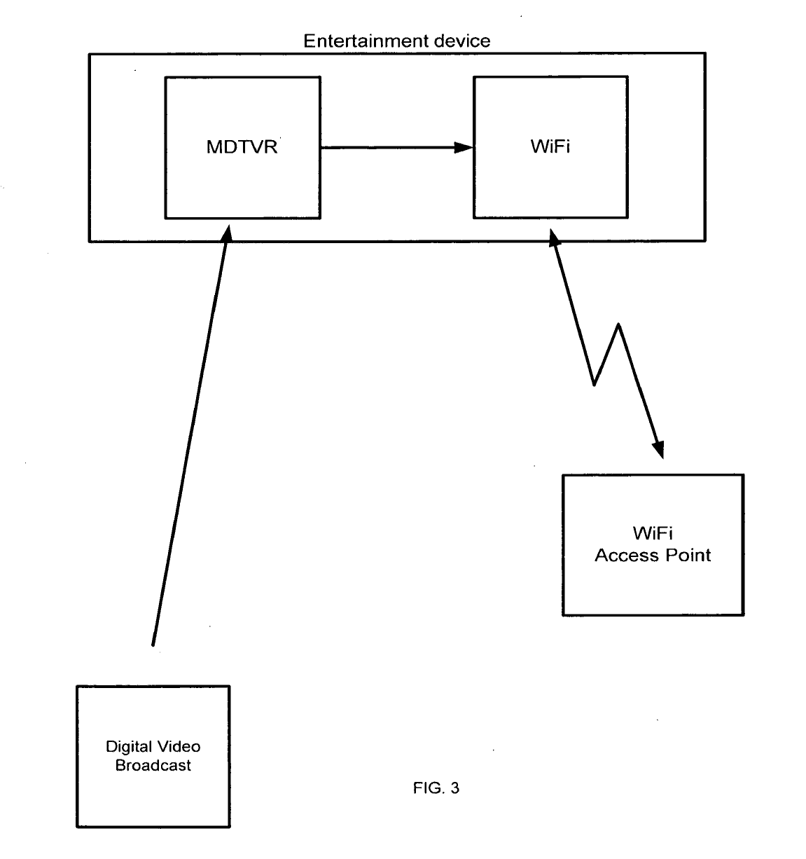

FIG. 3 shows an example of the system according to some embodiments of the invention, in this example there may be an entertainment device which may include a MDTV receiver and a WiFi transceiver. The MDTV receiver may receive a digital video signal from a digital broadcasting station. The MDTV receiver may send a message to the WiFi transceiver to inform it of the estimated times a video packet/signal is expected to be received and the estimated duration of the packet/signal. The WiFi transceiver, in response to the message it may have received from the MDTV receiver, may send a message to the WiFi access point informing it that it may enter a quiet state at a certain time and for a certain period. The WiFi access point may refrain from sending a signal or packets to the WiFi transceiver at the quiet state time period.

According to some embodiments of the present invention, while the first wireless data transceiver is in the quiet state, the second wireless data transceiver may refrain from sending a signal or a packet to the first wireless data transceiver. According to some embodiments of the present invention, while the first wireless data transceiver is in the quiet state, the second wireless data transceiver may buffer any data it might need to send during the quiet state time, and may send the buffered data after the quiet state ends. According to some embodiments of the present invention, while the first wireless data transceiver is in the quiet state, the second wireless data transceiver may not expect a reply to a signal or a packet it may send to the first wireless data transceiver.

According to some embodiments of the present invention, the MDTV receiver may receive a DTV signal or frame. According to some embodiments of the present invention, the DTV signal or frame may include the estimated time the next signal/frame should be expected and its estimated duration. According to some embodiments of the present invention, the MDTV receiver may communicate the expected time and duration of the next DTV frame to the first wireless data transceiver. According to some embodiments of the present invention, the first wireless data transceiver may send a message to the second wireless data transceiver informing it that it may enter a quiet state at the time and for the duration of the expected next DTV frame or signal. The DTV signal may be a periodic type of signal, an example of a periodic type of signal is shown in FIG. 2, according to this example the period time is T3, and the receiver may receive a signal T1/T3 of the time and receive no signal T2/T3 of the time. According to some embodiments of the present invention, the DTV/MDTV receiver may be adapted to determine or estimate the periodic pattern parameters of the digital video signal, such as period time, transmission time, idle time, and communicate these parameters to the first wireless data transceiver. According to some embodiments of the present invention, the first wireless data transceiver may use the information regarding the pattern of the periodic DTV signal, and may send recurring messages based on the periodic DTV signal nature, to the second wireless data transceiver, that it is entering a quiet state for a certain period of time. According to some embodiments of the present invention, the first wireless data transceiver may send to the second wireless data transceiver a message, informing the second wireless data transceiver that it will be entering a recurring quiet state for predetermined periods and durations. According to some embodiments of the present invention, upon reception of the recurring quiet state information from the first wireless data transceiver, the second wireless data transceiver may recurrently refrain from transmitting to the first wireless data transceiver at the quiet state time. According to some embodiments of the present invention, the first wireless data transceiver may receive DTV signal recurring information (such as period time, transmission time, idle time, frame start time) from the DTV receiver, and may correlate this information with the wireless data signal or frames it may receive and which may be transmitted by the second wireless data transceiver. According to some embodiments of the present invention, the first wireless data transceiver may be adapted to determine whether or not the wireless data signal is being received during the quiet state gap time, and may also determine whether there are enough margins between the time the wireless data signal ends and the DTV signal starts, and between the time the DTV signal ends and the wireless data signal starts. According to some embodiments of the present invention, in the case that the first wireless data transceiver determines that the wireless data signal and the DTV signal are not properly aligned, it may correct the DTV signal recurring parameters accordingly and send the new recurring parameters (the parameters that were updated or all the parameters) to the second wireless data transceiver.

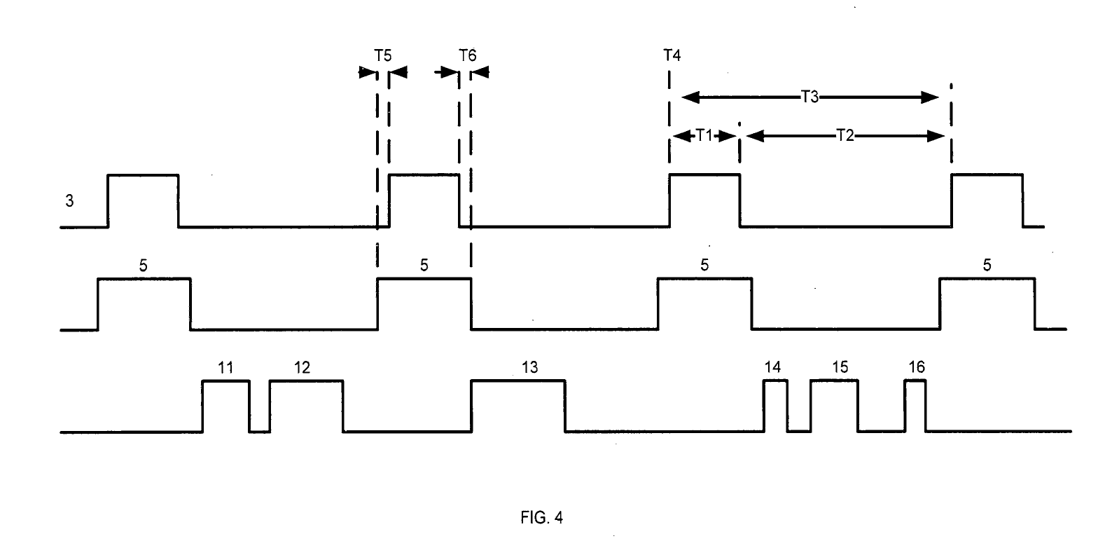

FIG. 4 shows an example of a periodic DTV signal 3 which has a recurring period of T3, a frame start time at T4, a transmission time of T1 and an idle time of T2. The MDTV/DTV receiver may receive the DTV signal, and may estimate the recurring parameters T1, T2, T3, T4. The DTV/MDTV receiver may communicate T1, T2, T3 and T4 to the first wireless data transceiver. In this example the first wireless data transceiver may enter a quiet state (5). The quiet state may have some margin T5 and T6 before and after the expected reception of the DTV signal. The first wireless data transceiver may send a message to the second wireless data transceiver containing the information T1-T6. Alternatively, the first wireless data transceiver may send a message to the second wireless data transceiver containing the information T1, T2, T5, T6, or T3, T1+T5+T6 or any other timing information determining the quiet state period and the recurring duration. In response to receiving the message from the first wireless data transceiver, the second wireless data transceiver may refrain from transmission during the quiet state and may or may not transmit during other times, in the example of FIG. 4, the second wireless data transceiver transmits during 11, 12, 13, 14, 15 and 16.

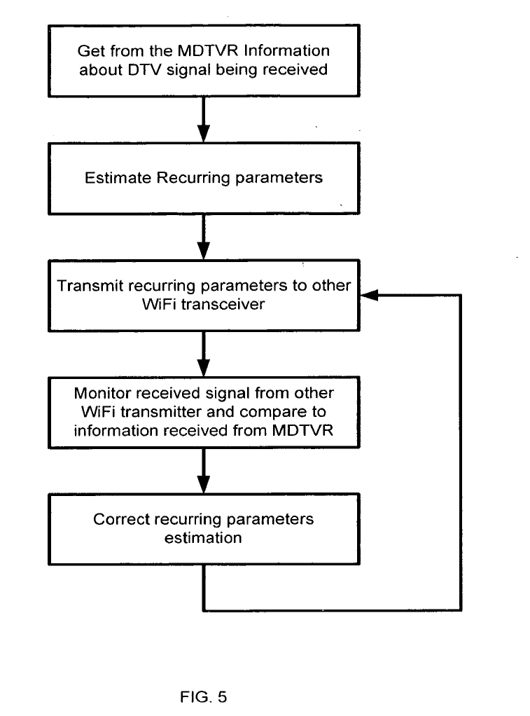

FIG. 5 is an exemplary flowchart describing the steps taken by the first wireless data transceiver. The first wireless data transceiver may receive from the DTV/MDTV receiver, information regarding the expected time and duration of a DTV signal or packets that are about to be received. The DTV/MDTV receiver may estimate the recurring pattern of the DTV signal and communicate it to the first wireless data transceiver. Alternatively, the first wireless data transceiver may receive from the DTV receiver information about the estimated time and duration of received DTV signals or packets, and may estimate the recurring parameters. The first wireless data transceiver may then send these parameters to the second wireless data transceiver, and enter a quiet state during the times when DTV packets are about to be received. During the quiet state, or during any other time, the first wireless data transceiver may receive information regarding the actual time of a received DTV signal or packet, and may receive a data signal or packet from the second wireless transceiver before, during, or after the quiet state. The first wireless data transceiver may correlate the times in which the DTV signals are received with the times in which the data signals are received, and may adjust or fine tune the estimated parameters of the expected recurring DTV signal. The firstwireless data transceiver may then send a message to the second wireless data transceiver with the updated parameters.

According to embodiments of the invention, there may be an entertainment device which may include or have attached to it a DTV/MDTV receiver circuit and a wireless data transceiver circuit. The DTV/MDTV receiver may receive a video signal which may be transmitted by a digital video source, and which may not be interfered by a data signal transmission of the wireless data transceiver. The wireless data transceiver may be in a quiet state during a video signal/frame reception and may perform data communication during the gap in-between the quiet state time periods.

According to some embodiments, the MDTVR may be integral with and/or may share resources with a collocated data transceiver. The MDTVR may shared and take turns using: (1) an LNA (Low Noise Amplifier), (2) a Synthesizer, (3) a Mixer, (4) a PGA (Programmable Gain Amplifier), (5) a ADC (Analog to Digital Converter), (6) Time-Domain Logic, (7) FFT (Fast Fourier Transform), (8) Control Logic and memories, and any other resource which may be applicable to both.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A wireless data transceiver comprising:
a transceiver controller adapted to receive from a functionally associated wireless digital video receiver an indication of expected arrival of a digital video frame and to respond to the indication by generating and transmitting to one or more wireless data transmitters a wireless indicator signal or packet indicating that said wireless data transceiver is entering a low-power or standby mode/state for some predefined period of time.

2. The transceiver according to claim 1, further comprising radio frequency transmission circuitry.

3. The transceiver according to claim 2, further comprising radio frequency reception circuitry.

4. The transceiver according to claim 3, wherein said transceiver is adapted to operate substantially in accordance with the WiFi standard.

5. The transceiver according to claim 1, wherein said controller is adapted to receive from the functionally associated wireless digital video receiver a signal indicating one or more parameters associated with a pattern of recurring/periodic MDTV frame reception.

6. The transceiver according to claim 5, wherein the one or more parameters is selected from the group consisting of duration of frame, interval between consecutive frames, and temporal reference point/time.

7. The transceiver according to claim 6, wherein said controller is further adapted to determine or estimate during which time periods a MDTV frame is to be received based on the signal indicating the one or more parameters.

8. The transceiver according to claim 7, wherein said controller is further adapted to intermittently transmit a wireless indicator signal or packet indicating that said wireless data transceiver is entering a low-power or standby mode/state for some predefined period of time prior to the determined or estimated time period.

9. The transceiver according to claim 1, wherein said transceiver shares resources with the wireless digital video receiver.

10. A mobile digital video receiver comprising:
a wireless receiver controller adapted to generate and transmit to a functionally associated wireless data transceiver an indication of an expected arrival of a digital video frame, which indication is adapted to cause the functionally associated wireless data transceiver to generate and transmit to one or more wireless data transmitters an indicator signal or packet indicating that the wireless data transceiver is entering a low-power or standby mode/state for some predefined period of time.

11. The receiver according to claim 10, further comprising radio frequency reception circuitry.

12. The receiver according to claim 11, wherein said radio frequency reception circuitry is adapted to operate substantially in accordance with an MDTV standard.

13. The receiver according to claim 10, wherein said controller is adapted to detect, determine or estimate one or more parameters associated with a pattern of recurring/periodic MDTV frame reception.

14. The receiver according to claim 13, wherein the one or more parameters is selected from the group consisting of duration of frame, interval between consecutive frames, and temporal reference point/time.

15. The receiver according to claim 13, wherein said controller is further adapted to convey the one or more parameters to the functionally associated wireless data transceiver.

16. The receiver according to claim 10, wherein said receiver shares resources with the associated wireless data transceiver.

17. A method comprising:
estimating a time of arrival of digital video frame at a wireless video receiver;
transmitting to a functionally associated wireless data transceiver an indication of the estimated arrival of a digital video frame; and
transmitting to one or more wireless data transmitters an indicator signal or packet indicating that the wireless data transceiver is entering a low-power or standby mode/state for some predefined period of time.

18. The method according to claim 15, wherein the wireless video receiver operates in substantial compliance with an MDTV standard.

19. The method according to claim 15, wherein the functionally associated wireless data transceiver operates in substantial compliance with a WiFi standard.

20. The method according to claim 17, wherein the one or more wireless data transmitters refrain transmitting to the transceiver during the predefined period of time.
